(19) United States
(12) Patent Application Publication
(10) Pub. No.: US 2015/0189075 A1
(43) Pub. Date: Jul. 2, 2015

(54) METHODS AND SYSTEMS FOR CHARACTERIZING LINE MICRO-FILTER STATES & POSITIONING LINE FAULTS RELATIVE TO A NETWORK INTERFACE DEVICE

(71) Applicants: Chan-Soo Hwang, Sunnyvale, CA (US); Geoffrey G. Moyer, Portola Valley, CA (US); Mark Flowers, Los Gatos, CA (US); Mohammad Naghshvar, San Diego, CA (US)

(72) Inventors: Chan-Soo Hwang, Sunnyvale, CA (US); Geoffrey G. Moyer, Portola Valley, CA (US); Mark Flowers, Los Gatos, CA (US); Mohammad Naghshvar, San Diego, CA (US)

(21) Appl. No.: 14/384,379

(22) PCT Filed: Mar. 12, 2012
(86) PCT No.: PCT/US2012/028751

§ 371 Date: Sep. 10, 2014

(51) Int. Cl. H04M 3/30; H04B 3/46; H04M 3/22; H04M 11/06

(52) U.S. Cl. CPC H04M 3/30; H04M 11/062; H04B 3/46; H04M 3/2209

(57) ABSTRACT

Systems and methods for probing and/or monitoring DSL activity on a line from the CPE side. In embodiments, detected Public Switched Telephone Network (PSTN) line states are associated with line data collected to determine a state of a microfilter on the line. Locations of other line faults are positioned relative to a network interface device (NID) based on a comparison of dry and active CPE lines or based on an estimate of the NID location.

### TECHNICAL FIELD

The subject matter described herein relates generally to the field of telecommunication, and more particularly to systems and methods for diagnosing and optimizing performance of a digital subscriber line (DSL).

### BACKGROUND

Digital subscriber line (DSL) technologies generally include digital subscriber line equipment and services using packet-based architectures, such as, for example, Asymmetric DSL (ADSL), High-speed DSL (HDSL), Symmetric DSL (SDSL), and/or Very high-speed/Very high-bit-rate DSL (VDSL). Such DSL technologies can provide extremely high bandwidth over a twisted pair line and offers great potential for bandwidth-intensive applications. DSL services in the 30K-30 MHz band are however more dependent on line conditions (for example, the length, quality and environment of the line) than is Plain Old Telephone Service (POTS) operating in the <4K band.

While some loops are in good condition for implementing DSL (for example, having short to moderate lengths with operative micro-filters or splitters correctly installed and with no bridged taps and no bad splices), many loops are not as suitable. For example, loop length varies widely, the wire gauge for a loop may not be consistent over the length of the loop (having two or more different gauges spliced together), micro-filters can be in a fault state (e.g., absent, reversed), and many existing loops have one or more bridged taps (a length of wire pair that is connected to a loop at one end and is unconnected or poorly terminated at the other end).

Because the number of lines may be very great, line service providers typically attempt to provision lines so that a certain minimal level of line performance and stability is achieved in a manner which will require little, if any, further consideration by the provider. Also, in some locations, a DSL services wholesaler provides DSL communication equipment to form an infrastructure for such services and DSL service resellers then sell DSL services (e.g., “Internet access”) delivered over that infrastructure to individual end users. Because the DSL services wholesaler controls the equipment forming the DSL infrastructure and the DSL services reseller maintains a services relationship with the consumers, conflicts may exist between a DSL services wholesaler most interested in protecting the integrity of the infrastructure and a DSL services reseller desiring access and control of the equipment for the sake of managing service quality to their end users.

Whether the services are provided to the end customers by the wholesaler or a reseller service provider, loop impairments on the Customer Premises Equipment (CPE) side of the line, downstream of a network interface device (NID), are typically the responsibility of the customer. Microfilter faults, bridged taps, bad splices, etc. present within home wiring may not be readily deduced from the service provider side nor of particular concern to a service provider where the minimal level of line performance and stability is nonetheless attained.

As performance limiting line issues may often be best identified from the CPE side, systems and techniques capable of identifying loop impairments from the CPE side and deducing their position relative to the NID are advantageous to the customer, a CLEC (Competitive Local Exchange Carrier), or other third party providing a line management service (and who may lack any access to the central office (CO) side).

### BRIEF DESCRIPTION OF THE DRAWINGS

Embodiments of the present invention are illustrated by way of example, and not by way of limitation, and can be more fully understood with reference to the following detailed description when considered in connection with the figures in which:

FIG. 1A is a hierarchical fault detection scheme which is implemented, in accordance with an embodiment;

FIG. 1B is a block diagram illustrating system for monitoring, probing, and detecting line impairments to implement at least a portion of the fault detection scheme illustrated in FIG. 1A, in accordance with an embodiment;

FIG. 2A is a flow diagram illustrating a method for detecting a microfilter state, in accordance embodiments;

FIG. 2B is a flow diagram illustrating a method for probing a line, and detecting a microfilter state based on collected probe data, in accordance with an embodiment;

FIG. 2C is a flow diagram illustrating a method for monitoring a line, and detecting a microfilter state based on collected operational data, in accordance with an embodiment;

FIG. 3 is a diagram illustrating an architecture for a fault template which may be employed in the methods for monitoring, probing, and detecting line impairments, in accordance with embodiments;

FIGS. 4A, 4B, 4C, and 4D are flow diagrams illustrating methods for characterizing a line with respect to the presence and/or location of a fault, in accordance with embodiments;

FIG. 5A is a schematic illustrating a network including the system of FIG. 1B to which methods for characterizing a line with respect to the presence and/or location fault is applied, in accordance with an embodiment;

FIGS. 5B and 5C illustrate a system for localizing line faults, in accordance with embodiments; and

FIG. 6 is a functional block diagram of a machine in the form of a computer system, configured in accordance with an embodiment.

### DETAILED DESCRIPTION

The following detailed description of the invention will refer to one or more embodiments of the invention, but is not limited to such embodiments. Rather, the detailed description is intended only to be illustrative. Those skilled in the art will readily appreciate that the detailed description given herein with respect to the Figures is provided for explanatory purposes as the invention extends beyond these limited embodiments.

As used herein, the term “service provider” refers to any of a variety of entities that provide, sell, provision, troubleshoot, and/or maintain communication services and/or communication equipment. Exemplary service providers include a telephone operating company, a cable operating company, a wireless operating company, an internet service provider, or any service that may independently or in conjunction with a broadband communications service provider offer services that diagnose or improve broadband communications services (DSL, DSL services, cable, etc.).

As used herein, the terms “end user,” “subscriber,” and/or “customer” are used interchangeably and all refer to a person, business and/or organization to which communication services and/or equipment are provided by any of a variety of service provider(s). Further, the term “customer premises” refers to the location to which communication services are being provided by a service provider. As an example, where the Public Switched Telephone Network (PSTN) is used to provide DSL services, customer premises are located at, near and/or are associated with the network termination (NT) side of the telephone lines. Exemplary customer premises include a residence or an office building.

Described herein are systems and methods for probing and/or monitoring DSL activity on a line from the CPE side. In embodiments, detected PSTN line states are associated with line data collected to determine a state of a microfilter on the line. The PSTN state, as detected, may be employed to trigger a line probing or a DSL operational data collection event and may be further employed to categorize the collected probe data or operational data in a manner conducive to analysis techniques including line data comparisons.

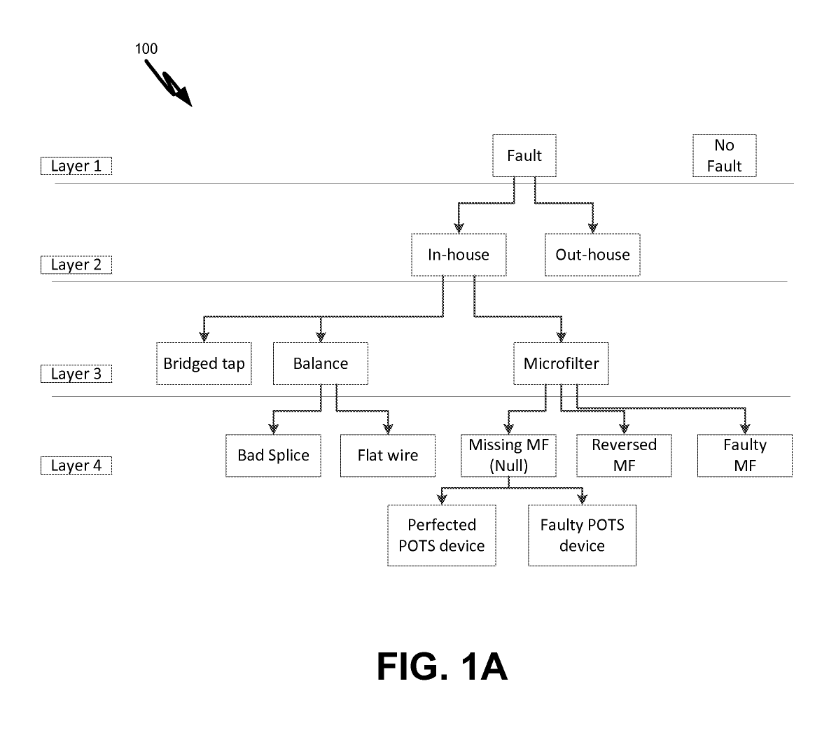

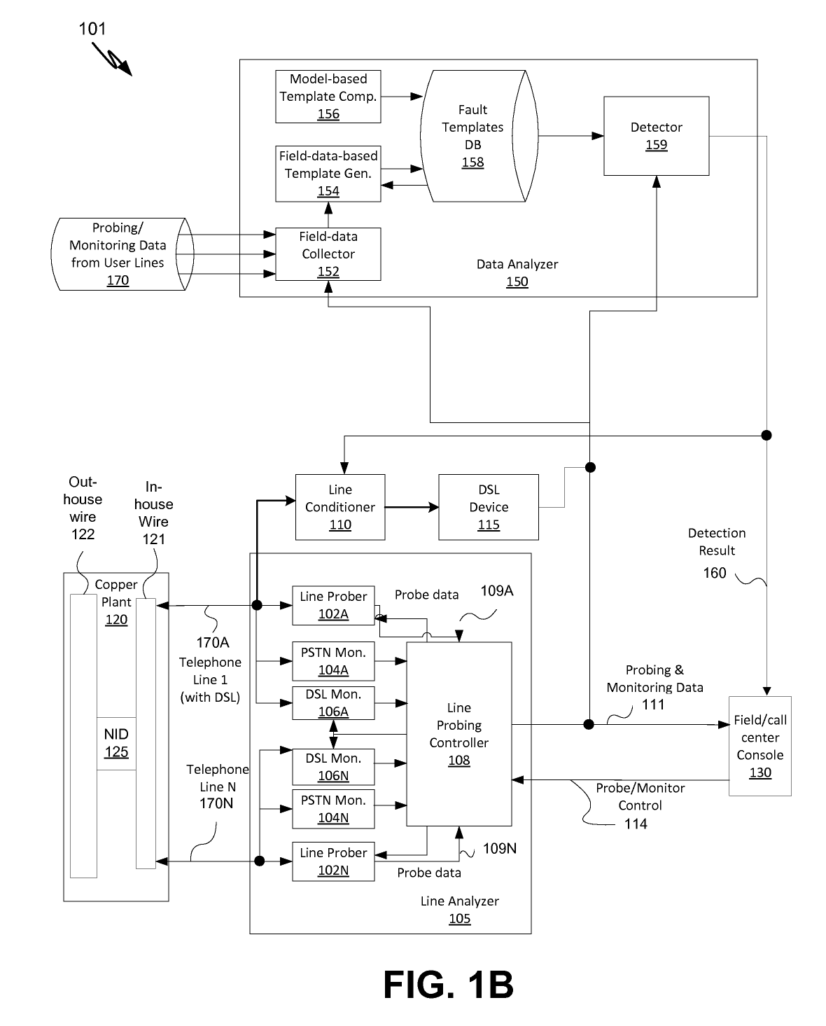

In embodiments, a line is characterized based on the hierarchical detection scheme 100 illustrated in FIG. 1A where a line impairment or “fault” detected at layer 1 is deduced to be either in-house or out-house at layer 2. In embodiments, at layer 2 a position of a line impairment or “fault” relative to a NID is determined based on line data collected through the systems and methods for probing described herein. The location of the fault may be determined based on a comparison of line probe data collected from both the “active” DSL line and a “dry line” on the CPE side lacking Plain Old Telephone Service (POTS) and DSL. In embodiments, the NID location is estimated based on the comparison and then the estimated NID location is compared to an estimated distance to the fault from the probe point. In other embodiments, a fault is deduced to be on either side of the NID based on commonalities or differences identified between a comparison of the probe data collected for active and dry lines.

At layer 3, in-house faults are further partitioned between microfilter issues and other in-house wire faults including bridged taps and balance issues, such as bad splices and flat wire. In one embodiment, a comparison between active and dry lines is utilized at layer 3. For layer 4, microfilter issues are partitioned into non-conforming microfilter states where the microfilter is not correctly configured, such as at least one of a “null” state where no microfilter is present on the line, a “reversed microfilter” state where a phone side of the microfilter is connected to the line side, and a “faulty” microfilter state where a microfilter is present but not fully operational. For the null microfilter state, a further distinction may be made between a perfected POTS device and a faulty POTS device which degrades DSL service even when the device is “on-hook.” In embodiments, microfilter states are determined based on comparisons with templates associated with a particular microfilter state. The templates may be stored and aggregated from field data collected from other user lines or generated from a model-based template computation.

FIG. 1B is a block diagram illustrating system 101 for monitoring, probing, and detecting line impairments, in accordance with an embodiment. The system 101 is to perform the various probing, monitoring, and detecting techniques described herein. System 101 includes a line analyzer 105 coupled to at least a first a twisted pair telephone line 170A. The analyzer 105 may take the form of a stand-alone device (e.g., a set-top box), or an embedded device (e.g., DSL modem chipset), etc. For example, in one embodiment, the line analyzer 105 is a chipset of a CPE modem communicably interfaced with the first end of the line 170A. In another embodiment, the line analyzer 105 is a chipset of a line conditioner 110, physically separate and distinct from a CPE modem. For such an embodiment, a CPE modem is communicably interfaced with the first end of the line 170A through the line conditioner 110 that further coupled to the line 170A. The line conditioner 110 may be a stand-alone device (e.g., a set-top box), or an embedded device (e.g., DSL modem chipset), etc. and is generally to optimize line conditions, for example through noise and/or echo cancellation, signal conditioning etc., and may for example comprise a filter bank utilizing filter coefficients generated via any filtering techniques known in the art. In yet another embodiment, the line analyzer 105 is a controller card configured within a CPE modem communicably interfaced with the first end of the line 170A to inject the generated probe from the controller card via the CPE modem onto the line. In one embodiment, the line analyzer 105 is a controller card configured within the line conditioner 110. The line conditioner 110 is then communicatively interfaced with a first end of the line 170A and the CPE modem is interfaced line 170A through the signal conditioning device.

The line 170A forms a portion of an in-house wiring side of the copper plant 120. The copper plant 120 further comprises out-house wire 122 upstream of the NID 125. The NID 125 interfaces at least the line 170A to the out-house wire 122. The line 170A is therefore “active,” supporting at least POTS service accessible through a POTS device (not illustrated) coupled to the line 170A. In the exemplary embodiment, the line 170A supports POTS and also DSL service, with the DSL service provisioned through a DSL device 115 (e.g., CPE modem) coupled to the line 170A.

Whether the DSL technology is ADSL, HDSL, SDSL, and/or VDSL, the technology is implemented in accordance with an applicable standard such as, for example, the International Telecommunications Union (I.T.U.) standard G.992.1 (a.k.a. G.dmt) for ADSL modems, the I.T.U. standard G.992.3 (a.k.a. G.dmt.bis, or G.adsl2) for ADSL2 modems, I.T.U. standard G.992.5 (a.k.a. G.adsl2plus) for ADSL2+ modems, I.T.U. standard G.993.1 (a.k.a. G.vds1) for VDSL modems, I.T.U. standard G.993.2 for VDSL2 modems, I.T.U. standard G.994.1 (G.hs) for modems implementing handshake, and/or the I.T.U. G.997.1 (a.k.a. G.ploam) standard for management of DSL modems. The DSL device 115 therefore is to implement one or more of these DLS technologies following one or more of these standards.

In the illustrated embodiment, the line analyzer 105 includes at least one line prober 102A, PSTN monitor 104A, and DSL monitor 106A coupled to the line 170A. The line prober 102A may be any device know in the art for sending a test stimulus on the line 170A and measuring a response to the stimulus. In one exemplary embodiment the line prober 102A includes a reflectometry unit, where a predetermined test signal is sent from the line prober 102A, as the test point, onto the line 170A. The line 170A, as coupled to the out-house wire 122, reflects a portion of the signal back to the line prober 102A as the stimulus response. The line prober 102A is then to provide probe data 109A to a line probing controller 108. In addition to collecting the probe data 109A, the line probing controller 108 is further to control the line probing performed by the line prober 102A, for example by triggering a line probing of a particular type based on inputs received from other parts of the system 101.

The PSTN monitor 104A is to monitor PSTN states of the line 170A. In an embodiment, the PSTN monitor 104A is to detect the presence of a Direct Current (DC) voltage on the line 170A. The presence of this “battery” voltage informs the line analyzer 105 that line 170A is “active” and has at least POTS connectivity. In further embodiments, the PSTN monitor 104A is to detect at least one of an on-hook, off-hook, or a ringing state of the line 170A. For each of the on-hook, off-hook and ringing states, a battery voltage remains present, and so detection of these states may be conditioned on the presence of DC voltage. The PSTN monitor 104A may distinguish the off-hook state from the on-hook state through line impedance measurements or DC voltage for example, as well as detect the ringing signal received by the POTS device. As shown in FIG. 1B, the PSTN monitor 104A is coupled to line probing controller 108 so that the line probing controller 108 can trigger the line prober 102A based on determined PSTN states of the line 170A. In one exemplary embodiment, the line probing controller 108 is to trigger a probing of the line 170A by the line prober 102A in response to the line 170A being in a state conducive to the collection of probe data germane to characterizing the line 170A in a particular capacity, as further described herein in the context of one or more methods performed by the system 101.

In embodiments, the DSL monitor 106A is to monitor DSL activity on the line 170A and report out such activity to the line probing controller 108. In an embodiment, the line probing controller 108 is to control the DSL monitor 106A by triggering monitoring/collection of certain protocol information. Triggering of the DSL monitor 106A, may further be in response to the PSTN monitor 104A detecting the line to be in a particular PSTN state. For example, in one exemplary embodiment, where a microfilter state of the line 170A is to be determined, the probing controller 108 may trigger the DSL monitor 106A to collect signal spectrum during each of an on-hook state and off-hook state, as determined by the PSTN monitor 104A and reported to the probing controller 108.

The DSL monitor is configured to collect DSL “operational data” which is data generated by the operation of a DSL device on the line 170A. Such operational data includes the transmitted and/or received signal spectrum of a DSL device on the line 170A as well as DSL management protocol information generated by a DSL device. As one example of an embodiment employing signal spectrum, a received signal spectrum is estimated by: (1) arranging received signal as a sequence of N-sample blocks; (2) applying windowing function to each block; (3) taking Fourier transform of the windowed blocks; and (4) taking average of the Fourier transform outputs over multiple blocks. DSL management protocol information includes, but not limited to, frequency-dependent measured insertion loss, frequency-dependent measured quiet-line or active-line quiet line noise, channel average attenuation measurements (e.g. LATN, SATN), channel bit distributions, channel transmit power levels, time stamps for evaluating mutual effects and absolute time-dependent line conditions, carrier masks (e.g., CARMASK of G.997.1 or similar), and tone-spectral shaping parameters (PSDMASK), reported current data rates, reported maximum attainable data rates, reported error-correction-parity, reported use of trellis codes, HLOG[n], measured channel gain, measured channel phase, inferred data regarding individual users' power levels, operational data regarding individual users' code settings, the frequency/tone index of highest noise change in a recent time interval, the total number of bit-swaps occurring in a recent time interval, the distribution of FEC errors, code violations or errored seconds violations over several successive sub-intervals of a time interval, measured noise power variations, measured peak-to-average power ratio, measured channel logarithmic magnitude, measured quiet-line noise levels, measured active-line noise levels, mean square error per tone, MSE[n], signal-to-noise ratio per tone, SNR[n], count of ATM or other protocol cells, measured higher level protocol-throughput, count of retraining, count of failed synchronization attempts, reported carrier mask, reported tone-shaping parameters, inferred data regarding vectored or matrix channel characterization, echo response, received echo noise, and loop impedance.

Depending on the desired characterization of the line, either or both signal spectrum and protocol information may be utilized. For example, in one embodiment both received signal spectrum and Hlog (directly collected as part of protocol information or derived from other protocol information) are utilized.

In embodiments, the line probing controller 108 is to further control the line prober 102A based on the input from the DSL monitor 106A so as to minimize interference to DSL communication. For example, the line probing controller 108 may trigger the line prober 102A to perform a predetermined “inactive line” reflectometry routine in response to the DSL monitor 106A detecting that there is no DSL activity, or trigger the line prober 102A to perform a predetermined “active line” reflectometry routine in response to the DSL monitor 106A detecting that there is DSL activity. As described further elsewhere herein the “active line” reflectometry routines may be tailored based on the DSL activity detected by the DSL monitor 106A.

The line probing controller 108 is further coupled to resources external to the line analyzer 105 to which line probe and/or monitor data 111 is output and from which line probe and/or monitor control signals 114 are input. In certain embodiments, the system 101 includes a field/call center console 130 through which an interface to the line probing controller 108 is provided. In embodiments, the field/call center console 130 is a handheld or other device including a computing platform executing an application which is to perform one or more of the following: trigger the line prober 102A to probe the line 170A (e.g., as verification following a line repair); configure parameters of a line probing stimulus (e.g., to minimize interference to other communication signals on the line); configure parameters of the PSTN monitor 104A (e.g., to select a particular PSTN state to detect), configure parameters of the DSL monitor 106A (e.g., to select one of ADSL, HDSL, VDSL, etc.); configure parameters of the line probing controller 108 (e.g., to select different lines for probing); relay the probe and/or monitor data 111 (e.g. to a third party line management service); and display detection results (e.g., to a technician making a service call to troubleshoot the CPE).

The system 101 further includes a data analyzer 150 that is to receive the line probe and/or monitor data 111 from the line analyzer 105 (e.g., via the line 170A, or via the field/call center console 130) and/or receive DSL operational data collected by a DSL device on the line 170A. While the data analyzer 150 may be embedded into the line analyzer 105, in the exemplary implementation the data analyzer 150 is remote from the CPE, for example at a CLEC location or another third party location responsible for provisioning the analysis service represented by the data analyzer 150.

In one embodiment the DSL device 115 provides operational data to the data analyzer 150 through a network element management protocols such as the G.997.1 standard specification of the physical layer management for DSL transmission systems based on the clear embedded operation channel (EOC) defined in G.997.1 and G.99x standards. Notably, the DSL device reporting to the data analyzer 150 need not be a modem, but rather merely capable of collecting operational data from the line that is generated through operation of a Digital Subscriber Line (DSL) modem on a channel. Thus, while in certain embodiments, the DSL device reporting to the data analyzer 150 includes a modem, in other embodiments a separate device, such as a DSL signal booster that lacks a modem, collects the operational data generated as a result of show-time operation. In further embodiments, the DSL monitor 106A collects operational data generated as a result of show-time operation.

The data analyzer 150 includes a detector 159 that is to detect a line fault and/or position a line fault relative to the NID 125 as a means of diagnosing line faults from the CPE side. Depending on the embodiment, the detector 159 is to perform the detection, based, on either the collected line probe and/or monitor data 111 or the collected operational data. In certain embodiments, the detector 159 performs detection based on a comparison of the collected data across different PSTN lines states (as determined by the PSTN monitor 104A) and/or based on a comparison of the collected data to fault templates stored in the fault template database 158. As used herein, a database is any collection of data organized for the characterization of the line 170A. The database 158 is to be generated by one or more of: a model-based template computer 156; or a field-based template generator 154.

While the model-based template computer 156 is to compute a simulated or estimated probe response or vector of operational data parameter values for a given hypothetical line configuration, the field-based template generator 154 is to assemble sample templates from line probe and/or monitor data collected from a population of user lines 170 accessible to the data analyzer 150 (e.g., directly through a DSLAM or indirectly through a CO-side database, etc.). The field-data collector 152 is to sample the line probe and/or monitor data available from the field based on verification of a particular line characteristic. For the exemplary embodiment, where the data analyzer 150 is to determine a microfilter state of the line 170A, the fault template database 158 is to comprise templates associating probe data collected from a line in the field associated with a known microfilter state. Field data received by the field-data collector 152 that does not have a known microfilter state may either be discarded or held in abeyance until later time when a verification of the microfilter state is provided from an external source (e.g., a field technician).

The detector 159 is to report out a detection result 160. Depending on the embodiment, one or more devices may utilize the reported detection result 160 to either optimize the line 170A or to identify the line as having a particular estimated characteristic that potentially needs further diagnosis by a customer or field technician. For example, in the system 101, the detection result 160 is output to the line conditioner 110 so that a filter may reconfigure to compensate DSL communication on the line in a manner that better copes with the fault. As further illustrated in FIG. 1B, the detection result 160 may also be output to the field/call center console 130 for use by a field technician and/or as a feedback loop to direct the line probing controller 108 with a further probe and/or monitor control signal 114.

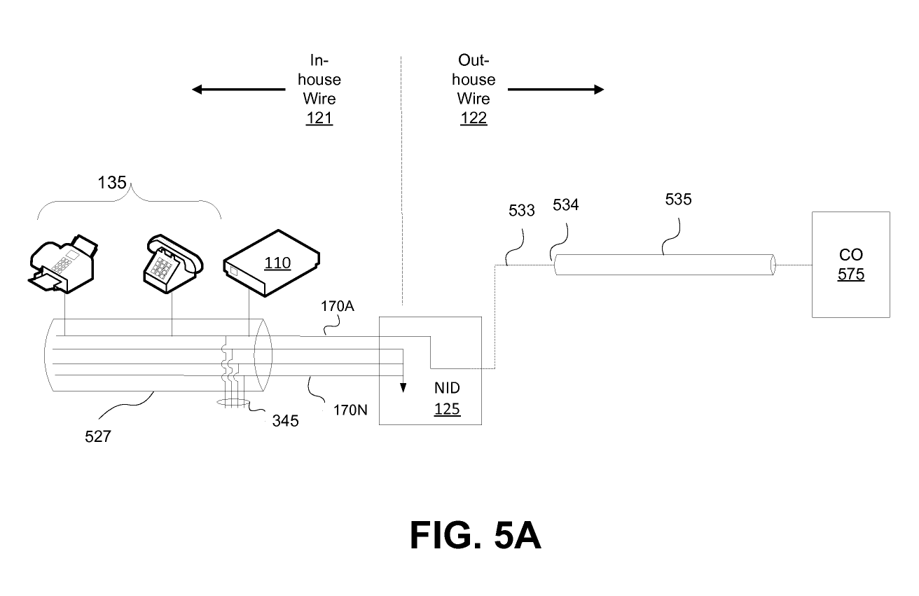

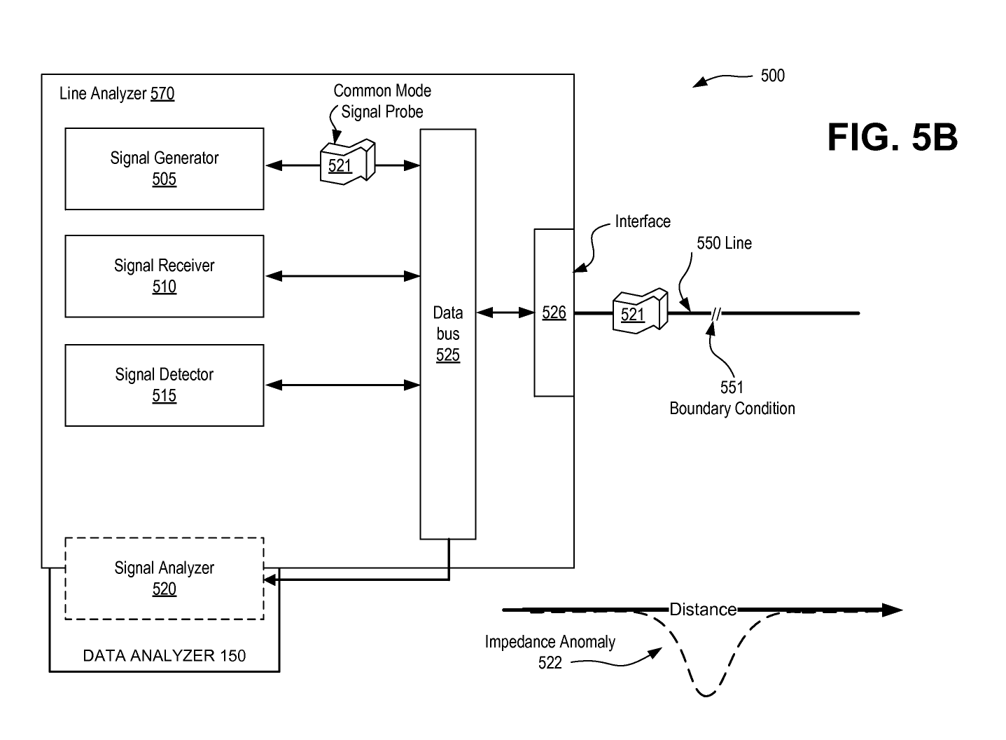

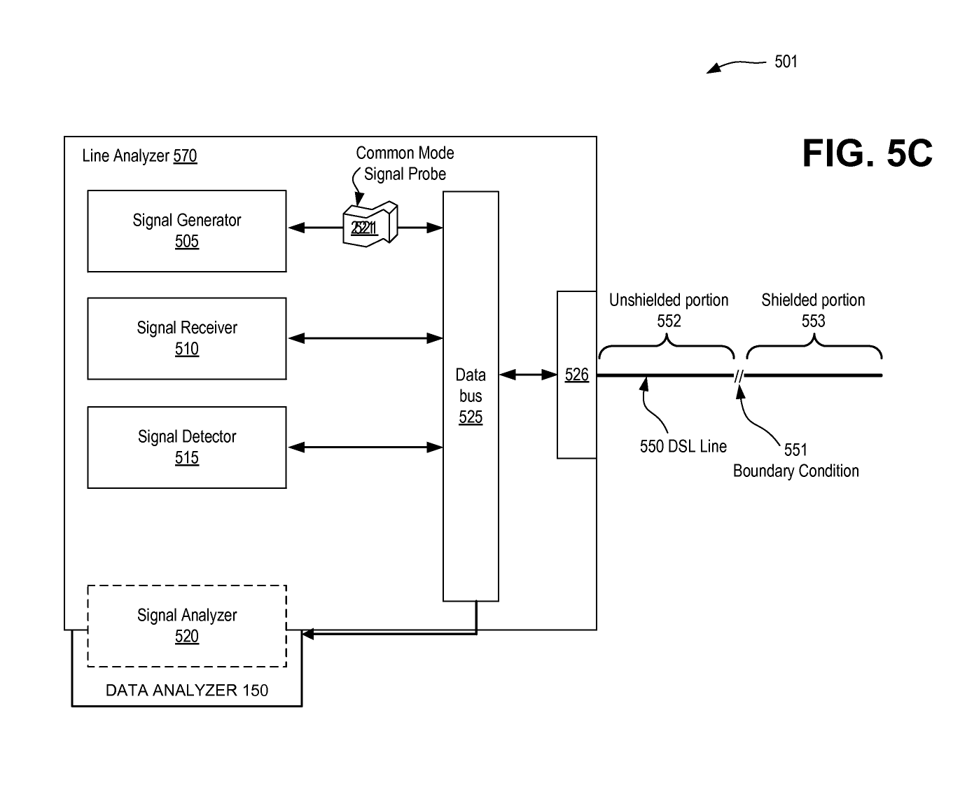

In embodiments, the line analyzer 105 is further coupled additional lines 170N comprising the in-house wire 121. One or more of a line prober, PSTN monitor, and DSL monitor may be coupled to the additional lines 170N to probe the lines and collect probe data, as represented in FIG. 1B by the line prober 102N, PSTN monitor 104N, and DSL monitor 106A. In one implementation, replication of these functional modules within the line analyzer 105 to provide probe data 109N is facilitated by a switch selectable between the lines 170A-170N. As described further herein, the analyzer 105 may collect data from the additional lines 170N to characterize the lines 170A (supporting DSL). In the exemplary embodiment, the line 170A is run in-house along with an unused (“dry”) line 170N, for example on quad cable (as Further illustrated in FIG. 5). The dry line 170N is terminated at the NID 125, however any splices, bridge taps, or other anomalies present on the line 170A can be expected to also be present on the dry line 170N. A difference between the probe data collected for the lines 170A and 170N removes the effect of the in-house topology generic to both the active line 170A and the dry line 170N and provides a means to partition the in-house wiring into line-specific and line-generic contributions.

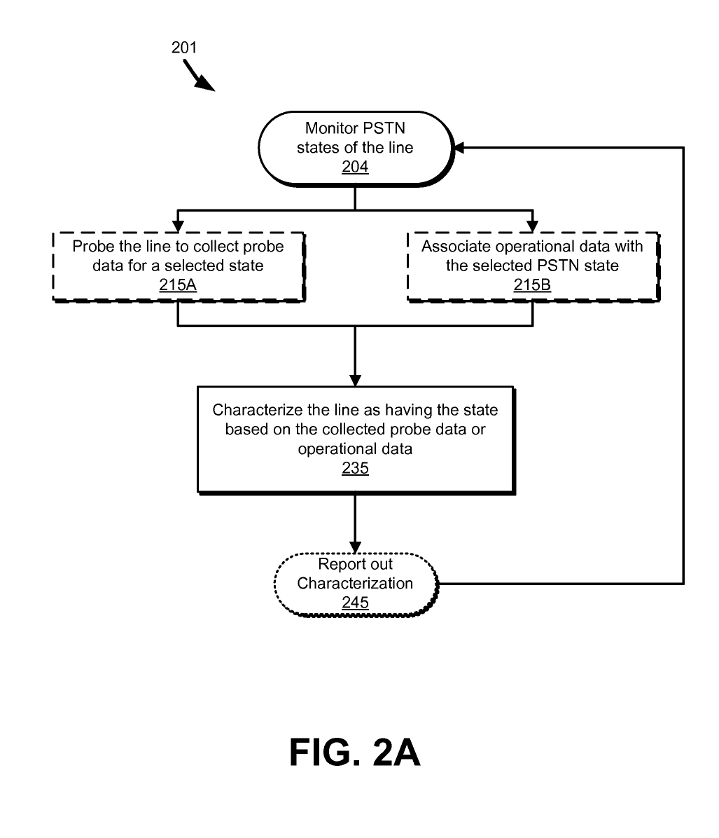

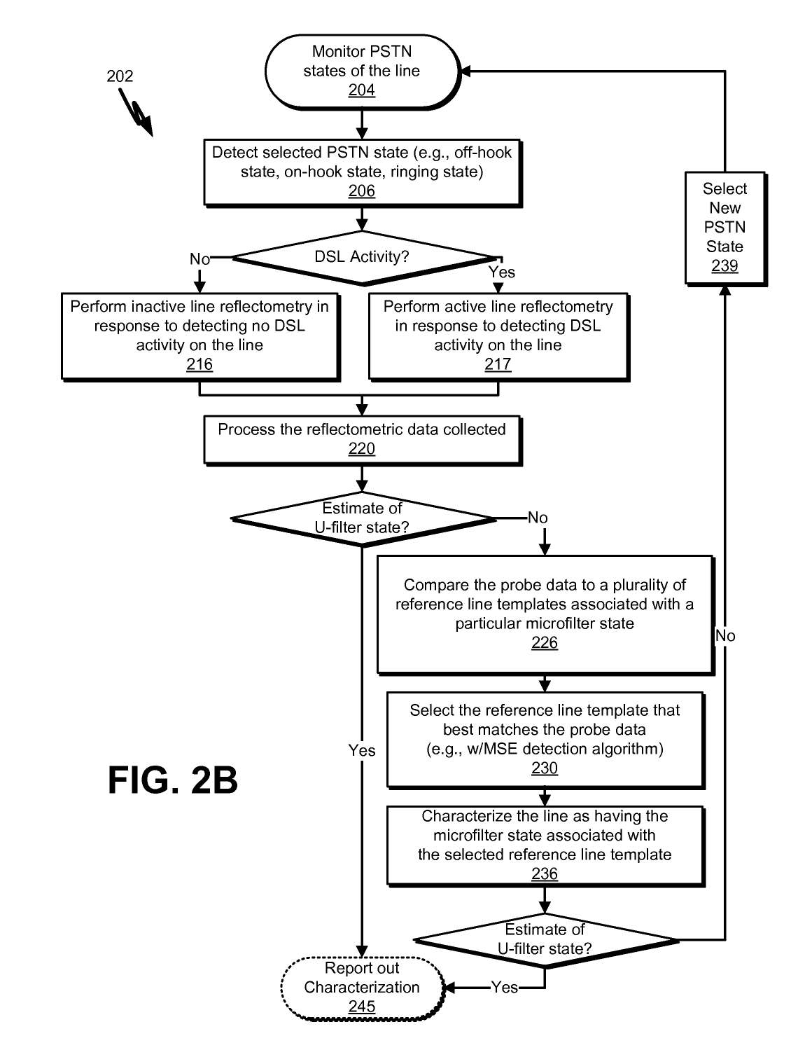

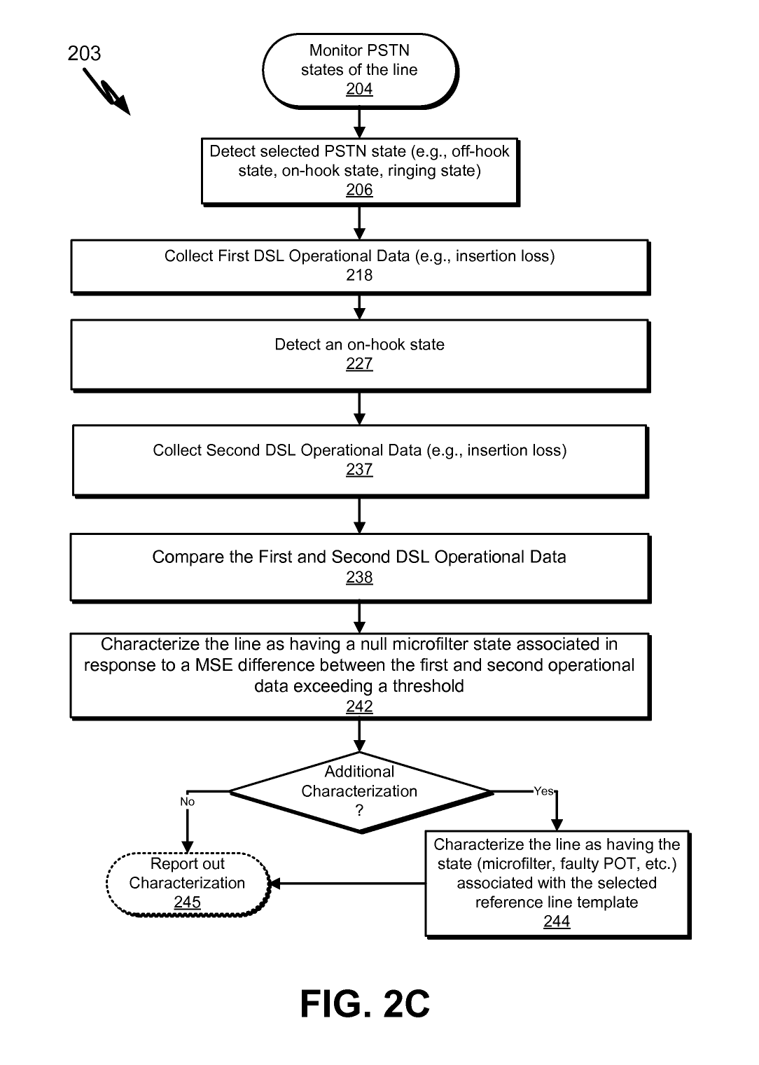

Methods performed and techniques employed by the system 101 are now described in reference to the functional components introduced in FIG. 1B. FIG. 2A is a flow diagram illustrating a method 201 for detecting a physical layer states on a telephone line which affect DSL performance on the line, in accordance embodiments. With the system architecture illustrated in FIG. 1B, many physical layer assessments of a telephone line may be, such as, but not limited, detection to bridged taps, bad splices, faulty POTs devices, and microfilter states. In a first embodiment, the data analyzer 150 is to characterize the line 170A at least with respect to a microfilter state. A microfilter is generally to be disposed on the line 170A to separate the low frequency band (e.g., <4K) used by POTS and the high frequency band (e.g., >30K) used by DSL. A missing, misapplied, or malfunctioning microfilter may attenuate the DSL signals and thus may seriously degrade DSL performance. As used herein, a microfilter state may be one of the following: a null microfilter state (where the microfilter is missing); a reversed microfilter (where the “phone side” is connected to the line); a faulty microfilter (where the microfilter is present but non-functional in some capacity); and a correctly-configured microfilter.

The method 201 begins at operation 204 with monitoring of at least the PSTN state of the line. As performance degradation attributable to an improper microfilter state is dependent on the on-hook and off-hook status of a POTS device on the line, it is advantageous for the system 101 to collect and associate any data collected from the line with a particular predetermined/selected PSTN state. For example when a POTS device is in an on-hook state within an ADSL system, the performance degradation attributable to a missing, reversed, or faulty microfilter state is small compared to when the microfilter is correctly-configured. However, when the POTS device is in an off-hook state within PSTN, the downstream data rate can be reduced by 3-6 Mbps due in part to an upstream signal echo that is injected into downstream signals.

In embodiments, operation 204 entails at least one of battery detection, on-hook detection, off-hook detection, and ring detection. In the system 101 (FIG. 1B) for example, at operation 204 the PSTN monitor 104A monitors the telephone line 170A to first determine the presence of a battery (DC voltage) and then performs on/off hook detection, as well as ring detection. In further embodiments, operation 204 further entails monitoring of DSL activity on the line (e.g., with the DSL monitor 104A) to determine whether DSL communication is occurring on the line at the time when the selected PSTN state is detected.

Following operation 204, the method 201 proceeds to either probe the line to collect probe data at operation 215A or to associate operational data at operation 215B with the PSTN state as determined at operation 204. Each of the operations 215A and 215B are illustrated in dashed line as being distinct types of data collection, and while both may be performed for a given line, they are separately described herein as alternate embodiments for the sake of clarity. Performance of either operation 215A or 215B may be triggered in response to detecting (at operation 204) the line to be in a selected PSTN state (e.g., off-hook). In a further embodiment, either operation 215A or 215B may be triggered in response to detecting the line to be in a particular DSL state. For example operation 215A may be performed in a first manner responsive to the PSTN state being “off-hook” (or “on-hook”) and the DSL state being “inactive” and a second manner responsive to the PSTN state being “off-hook” (or “on-hook”) and the DSL state being “active.” Similarly, show-time operational data may be collected at operation 215B in response to the PSTN state being “off-hook” (or “on-hook”) and the DSL state being “active,” indicating there is operational data being generated by one or more DSL device on the line that can be collected in association with the current PSTN state.

Following the collection of either probe data or operational data, the method 201 proceeds to operation 235 where the collected data is analyzed to estimate the a state for the line that best corresponds with collected data. Operation 235 is, for example, performed by the detector 159 in the system 101 with the line state output as the detection result 160 at operation 245. The method 201 may further be iterated as a means of detecting changes in the line or as a means of detecting more than one line fault. For example, where a first iteration is performed to identify a microfilter state (e.g., further following method 201 illustrated in FIG. 2B) a second iteration is performed to identify a faulty telephone (e.g., further following method 202 illustrated in FIG. 2C). Furthermore, a single iteration of the method 201 may generate data which may be analyzed in more than one manner to detect more than one line fault. For example, as further described elsewhere herein, both a microfilter state and a faulty POT device may be detected through one iteration of the method 201 (e.g., further following method 202 illustrated in 2C). Therefore, one or more of the methods described herein may be performed by the system 101 and one or more of bridged taps, bad splices, faulty POTs devices, and microfilter-related faults may be detected.

FIG. 2B is a flow diagram illustrating a method 202 for probing a line, and detecting a microfilter state based on collected probe data, in accordance with an embodiment. FIG. 2B is therefore illustrative of an embodiment of the method 201 (FIG. 2A) which employs probe data. Method 202 begins with PSTN state monitoring at operation 204, as previously described. At operation 206, the PSTN state selected (e.g., by PSTN monitor 104A, . . . , 104N), is detected. Line reflectometry may be performed in response to detecting any of the on-hook state, off-hook state, or a ringing state.

Generally, the line reflectometry (or other form of line probing for which the line prober 102A is configured) is to be performed with a probing signal selected to minimize the interference to/from the other communication signals (e.g., PSTN and DSL signals) on the line. The method 202 proceeds based on the DSL activity on the line (e.g., as determined by the DSL monitor 106A). If there is no DSL activity detected, inactive line reflectometry is performed at operation 216. As there is no concern that the probe stimulus will interfere with DSL communication activities on the line, one embodiment of operation 216 entails high pass filtering the probe stimulus to avoid the PSTN band if the PSTN state is off-hook. For a line in a “ringing” PSTN state, virtually any probe signal may be issued at operation 216.

If there is DSL activity detected, active line reflectometry is performed at operation 217. While in some embodiments, active line reflectometry may disrupt DSL communications, one or more techniques may be employed at operation 217 to minimize or avoid such disruption. In a first embodiment, the probe signal is high-pass filtered to avoid the PSTN band and a probe signal is injected over unused frequency tones (e.g., >1 MHz). In another embodiment, the probe signal may be applied during the SYNC symbol period. In another embodiment, the probe signal is high-pass filtered to avoid the PSTN band and the probe signal is injected over a subset of the frequency tones employed by a DSL modem on the line, with the subset being sufficiently small so as to maintain modem connectivity during the active line reflectometry. This technique essentially utilizes the disturb margin available on the line.

In further embodiments, the DSL frequency band used by the DSL modem is divided into a plurality of such frequency tone subsets and the probe signal is sequentially injected within each of the frequency tone subsets to individually disturb each subset at a given time. For example, a first subset may include DMT tones 32-42, a second subset may include tones 42-52, and a third subset may include tones 53-62. The probe data (e.g., reflection data) collected is then aggregated over the tone subsets to generate a reflectometry waveform spanning a plurality of the subsets over at least a portion of the DSL frequency band that would have caused a disruption but for the frequency band division.

In an embodiment, for either operation 216 or 217, the probing includes inducing reflection waveforms within the transition band (e.g., 10 KHz-30 KHz). Such probing is useful in differentiating between the faulty and correctly configured states of a microfilter. While the microfilter is specified to serve as a low pass filter with 60-80 dB suppression at over 30 KHz, in the interest of minimizing cost, a microfilter typically employs an elliptic filter which may be subject to ringing in the transition band. In embodiments where the line probing includes the transition band, an assessment of the transition band ringing may be included in the characterization of the microfilter state.

The method 202 continues at operation 220 where the collected reflectometric data is processed to differentiate microfilter issues from other in-house wiring faults. In one embodiment processing at operation 220 entails filtering of the traces, for example with a 500 KHz cut-off frequency, to reduce effects of short bridge taps. In another embodiment, probe trace data processing includes a comparison to previously collected traces to generate a differential signal. The previously collected traces may include any of: a trace collected from the same active line under test (e.g., line 170A in FIG. 1B) while in a different PSTN state (e.g., on-hook); a trace collected from the same line under test while in the same PSTN state (e.g., off-hook or ringing); or a trace collected from a different line in the same customer premises (same or different PSTN state as the active line under test).

In embodiments, multiple probe data sets for a same PSTN state may be processed at operation 220 to generate a statistic of the probe data for subsequent analysis. In other embodiments, the trace processing performed at operation 220 entails taking a difference between probe data collected while the PSTN state of the line is “on-hook” and probe data collected while the PSTN state of the line is “off-hook.” As previously described, comparisons between the off-hook and on-hook state are particularly useful for detection of the null microfilter state (e.g., at layer 4 in FIG. 1A). Where a magnitude of that difference exceeds a threshold, the null microfilter state indicative of a null microfilter may be reported out at operation 245, and for example a line conditioner may then reconfigure echo cancellation based on the ringing/on/off-hook state detection result.

In another embodiment where a probe data trace is collected from a different line collated in the same customer premises (e.g., line prober 102N collecting probe data 109N from the line 170N lacking DSL), a line comparison is performed to subtract out the contribution of in-house wiring topology not related to a microfilter. This comparison is useful for the layer 3 analysis (FIG. 1A) in view of the fact that if a DSL modem is not on a separate line (and therefore a microfilter is needed for POTS devices), the line supporting DSL is likely run in-house along with unused (“dry”) lines, for example on quad cable. Therefore, any splices, bridge taps, or other anomalies present on the line supporting DSL (e.g., line 170A) will typically also be present on the dry line 170N as impairments generic to all in-house line. The difference between the probe data traces calculated at operation 220 is then to remove such line-generic effects from the line-specific microfilter issues.

Continuing with the description of FIG. 2B, the method 202 proceeds to operation 226 where processing of the reflectometric data (or other probe data) does not directly generate an estimate of the microfilter state, or where the estimate generated is to be further tested. At operation 226, the collected probe data is compared to a plurality of reference line templates associated with a particular microfilter state. For example, referring to FIG. 1B, the probe data 111 may be compared to fault templates in the template database 158 having a same PSTN state for which the probe data was collected. As such, the PSTN state may be a key field employed to compare probe traces for like-states of a line. In further embodiments, DSL state and/or protocol information as well as the type of probing performed (e.g., active line reflectometry vs. inactive line reflectometry) may serve as a further basis for comparison of collected probe data to template probe data for comparable PSTN/DSL line states.

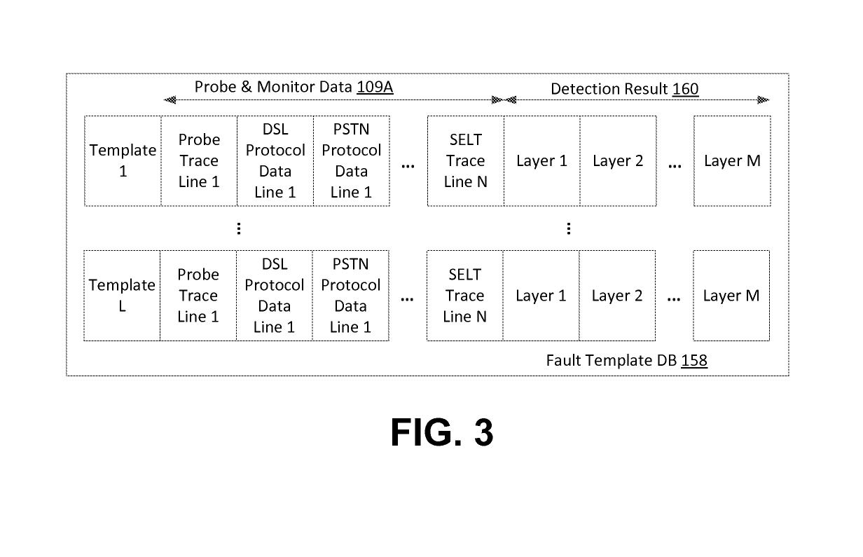

FIG. 3 is a diagram illustrating an architecture for a fault template stored in the fault template database 158, in accordance with embodiments. As illustrated, each template 1-L associates probe and monitor data 109A with particular detection results 160. The probe and monitor data 109A includes for each reference line 1-N, fields specific to the data type (probe trace or DSL protocol information) collected. The detection results 160 include fields for one or more layers of the detection scheme illustrated in FIG. 1A.

Returning to FIG. 2B, with a sufficiently populous fault template database 158, the line under test may be compared at operation 226 to a plurality of reference line templates associated with a null microfilter, compared to a plurality of reference line templates associated with a reversed microfilter, and compared to a plurality of reference line templates associated with a faulty microfilter. At operation 230, the reference line template having the probe trace data that matches the probe trace data collected for the line under test is selected. As one example, a mean square error (MSE) detection algorithm is utilized to identify the best match, though any other algorithm known it be suitable for such a purpose may also be utilized. In further embodiments, operation 230 may entail a Maximum Likelihood (ML) methodology, defining a measure of closeness, to find the fault template among the set that has the smallest difference from the collected data and is thus the most likely system configuration.

At operation 236, the line under test (e.g., line 170A) is characterized as having the microfilter state associated with the selected reference template (and also having any of the layer 1, 2, and 4 attributes defined by the best matching template).

A characterization of the microfilter state and/or any other fault attribute is then reported out at operation 245. In embodiments, method 202 is repeated, for example for a PSTN line state newly selected at operation 239 (e.g., “off-hook” where the previous iteration of method 202 was “on-hook,” etc.) to permit the processing operation 220 to determine differences between probe traces across PSTN states. The method 202 may be repeated indefinitely as long as a trigger (e.g., user-initiated command, an indication that the line is malfunctioning in a manner consistent with a microfilter fault, etc.) is satisfied as a means of managing the CPE side of the line.

The probe data collected may be added to the plurality of reference line templates (e.g., fault template database 158) in response to a confirmation that the microfilter on the line does in fact have the characterized microfilter state (e.g., via a technician visit or customer action). In further embodiments, before adding collected probe data as a new reference line template, a determination is made whether the collected probe data will represent a unique template.

FIG. 2C is a flow diagram illustrating a method for monitoring a line, and detecting a microfilter state based on collected operational data, in accordance with an embodiment. FIG. 2C is therefore illustrative of an embodiment of the method 201 (FIG. 2A) which employs DSL protocol information. Method 203 begins with PSTN state monitoring at operation 204, as previously described. At operation 206, a first PSTN state selected is detected, also as previously described. For example, in one embodiment, the “off-hook” PSTN state is detected.

At operation 218, first DSL operational data, such as, but not limited to an operational parameter vector including insertion loss and/or received signal spectrum, is collected from the line. Referring back to the system 101 (FIG. 1B), the first DSL operational data may be collected by either the DSL monitor 104A, or directly from the DSL device 115 in operation. The data collected at operation 218 is associated with the particular PSTN state detected (e.g., “off-hook”).

A second PSTN state is then selected (e.g., “on-hook” where the first PSTN state was “off-hook”) and upon detection of the second PSTN state at operation 227, second DSL operation data is collected at operation 237 in association with the second PSTN state. Generally, the first and second DSL operational data sets are to include at least some of the same line parameters. For example, in one embodiment both the first and second DSL operational data include at least insertion loss and/or received signal spectrum. At operation 238, first and second DSL operational data is compared, and at operation 242 the line from which the operational data was collected is characterized based on the comparison of the DSL operational data. For example, a null micro-filter state can be detected by noting changes in the operational parameters of the DSL system when the PSTN state changes from on-hook to off-hook, or vice versa, exceed a threshold. In another embodiment, the first and second operational data parameters (such as data rate and rate stability) are compared between on/off hook states to detect a faulty telephone where the parameter varies between the on/off hook states by more than the threshold.

At operation 244, either or both the first DSL operational data and second DSL operation data may be analyzed based on a comparison to the fault templates in substantially the same manner as was described elsewhere herein for probe trace data. For example, referring to FIG. 3, the operational data stored in a DSL protocol data field for fault templates may be compared to the first and/or second DSL operational data collected from the line to characterize the line as having a particular microfilter state of the best-matching fault template. Where a microfilter state is characterized at operation 242, operation 244 may be performed to detect other line states. For example, in one embodiment operational data stored in a DSL protocol data field for fault templates associated with a known faulty telephone is compared to the first and/or second DSL operational data collected from the line to characterize the line as having a faulty telephone.

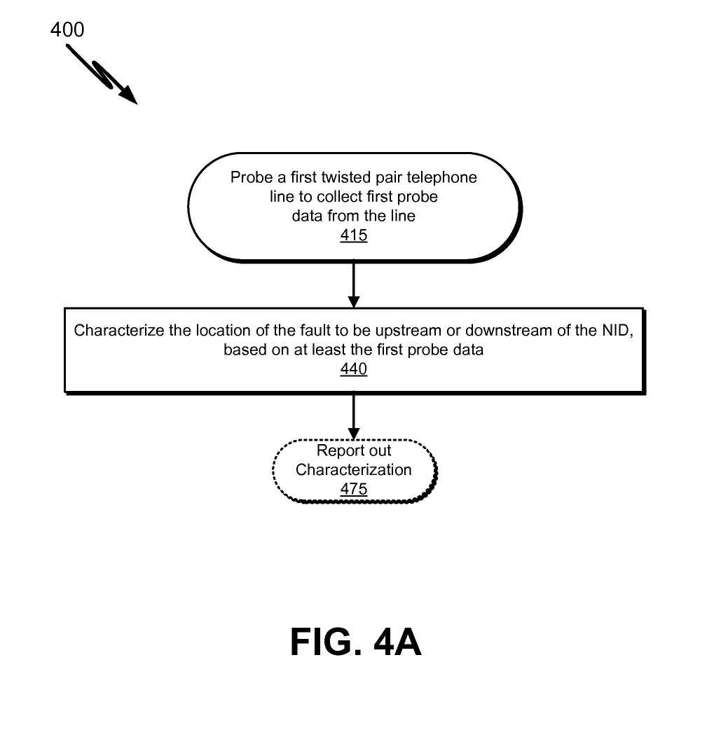

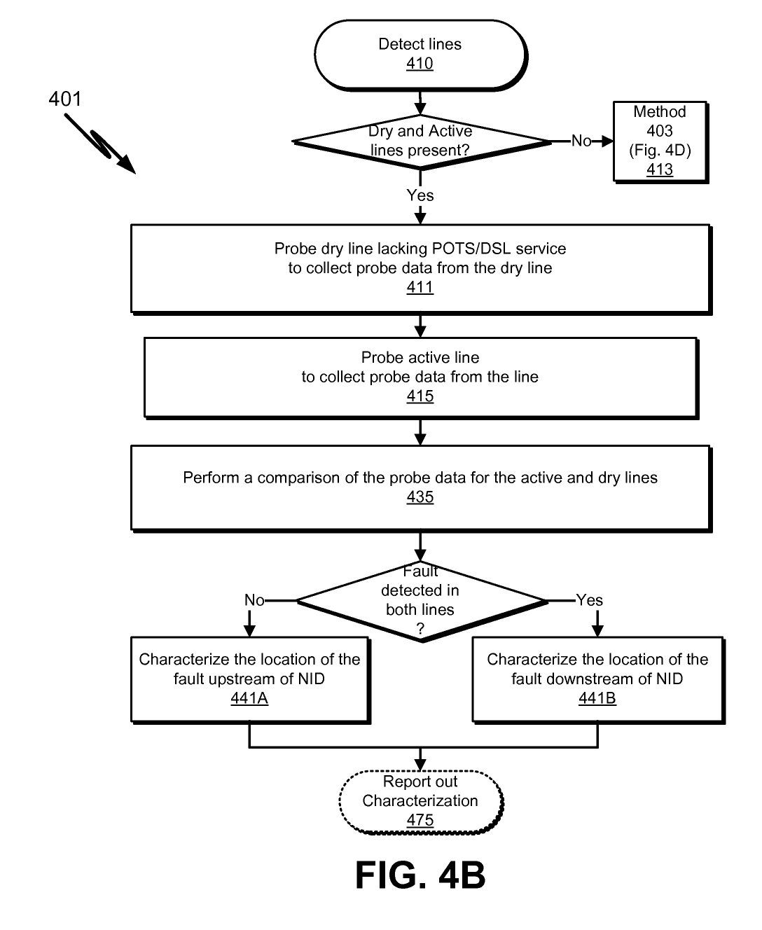

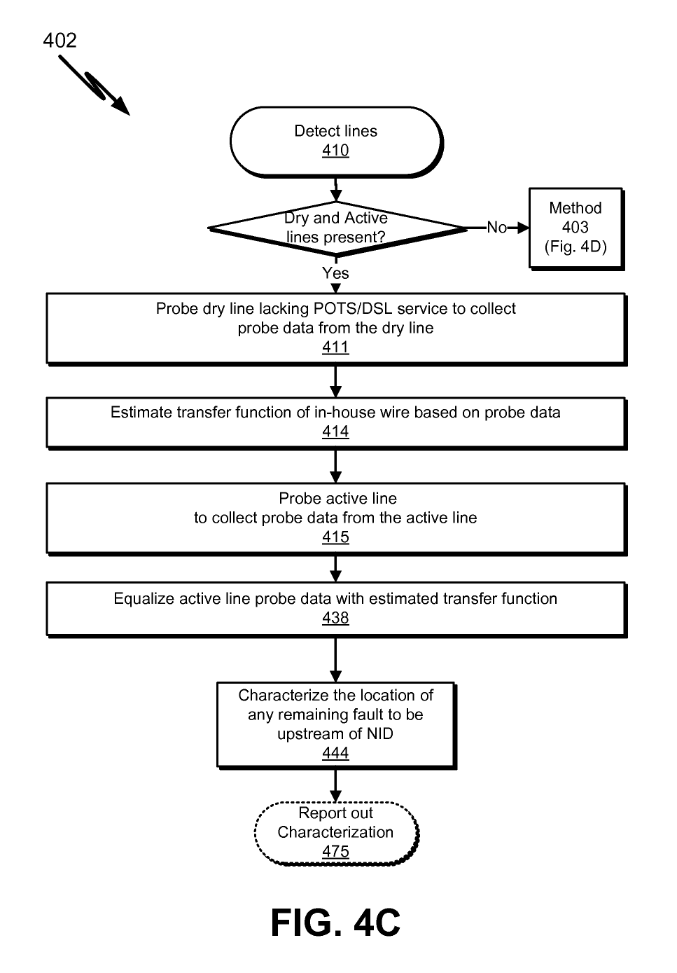

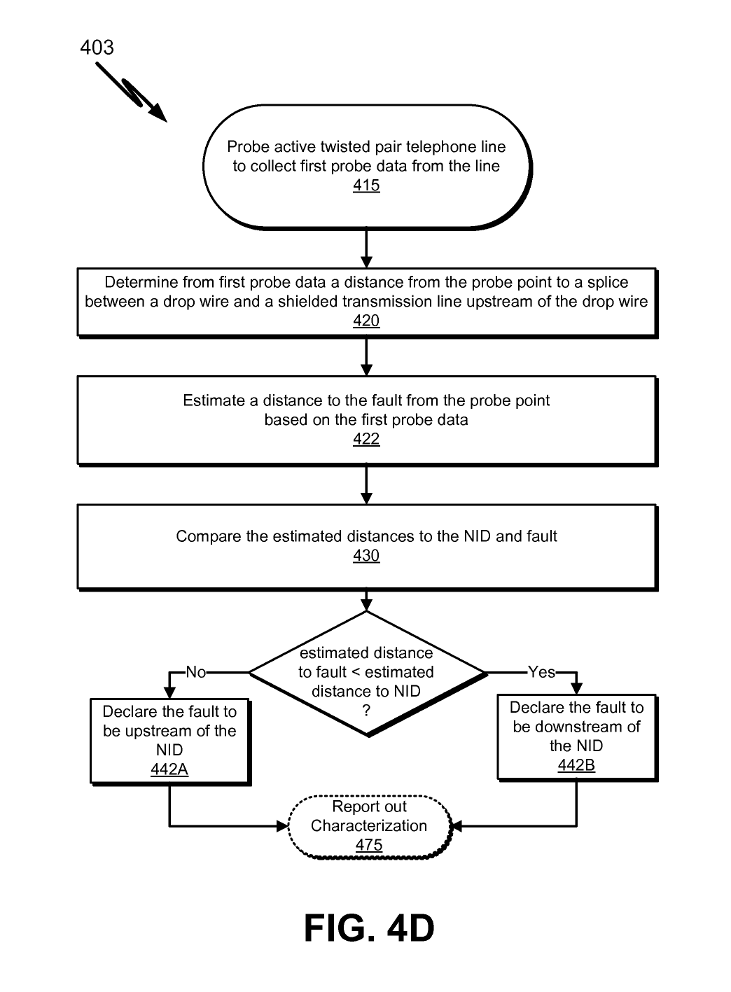

FIGS. 4A, 4B, 4C and 4D are flow diagrams illustrating methods for characterizing a line with respect to the presence and/or location of a fault (in accordance with embodiments. Since detected faults associated with microfilter states are assumed to be on the CPE side, FIGS. 4A, 4B, 4C and 4D are applicable to positioning/detection of other faults such as a bridge tap or bad splice. Such techniques may be employed for example to determine layer 2 of the hierarchical detection algorithm 100 (FIG. 1A).

Referring first to FIG. 4A, the method 400 includes probing a first twisted pair telephone line determined to support DSL service, as previously described (e.g., line 170A in FIG. 1B), to collect first probe data from the line at operation 415. At operation 440, a location of a detected fault is then characterized to be upstream or downstream of the NID, based on at least the first probe data. The characterization is then reported out at operation 475. Generally, the method 400 may entail at least one of: determining whether a detected fault is within the in-house wire (i.e., CPE side of NID) or out-house wire (i.e., CO side of NID) by comparing multiple lines on the CPE side; eliminating an effect of in-house wire so that faults detected are in the out-house wire; or determining the relative locations of a detected fault and the NID, as further illustrated by FIGS. 4B, 4C, and 4D, respectively. In the exemplary embodiment, a location for a fault relative to the NID is estimated only after each the methods illustrated by FIGS. 4B, 4C, and 4D is performed. In this manner, a higher confidence in the estimate may be possible through consensus/comparison of the estimates generated by each of the methods.

In FIG. 4B, method 401 begins at operation 410 with detecting the presence of an active line and any dry lines (lacking POTS and DSL service). A line (e.g., line 170A-170N in FIG. 1B) may be determined to be an active or dry line via the PSTN monitor 104N. In one embodiment for example, if no DC battery and/or no DSL activity is detected, that line is identified as being a dry line. In another embodiment, line length is estimated for all lines to which the line analyzer is coupled (e.g., lines 170A through 170N in FIG. 1B) using any technique known in the art. In another embodiment, where an estimated line length of the second line is substantially less than that of the first line, the second line is determined to be a dry line terminated at the NID.

If at least one dry line and at least one active line are detected, method 401 then proceeds to operation 411 where a dry line is probed, as previously described. At operation 415, an active line is similarly probed to collect probe data. If no dry line is detected, method 401 may proceed to operation 413 where method 403, illustrated in FIG. 4D, or another single-line characterization technique is performed.

At operation 435, a comparison of the collected probe data is made with the assumption that the dry line is co-located with the first line on customer premises. In a first embodiment, a fault detection technique known in the art, or based on the template matching techniques described elsewhere herein in the context of microfilter state detection (but also applicable to other faults) is performed on both the active and dry line. If a fault (e.g., bridged tap, bad splice, etc.) is detected based on the first probe data but the fault is not detected based on the second probe data, the location of the fault is declared at operation 441A to be upstream of the NID (e.g., within in-house wire 121). Conversely, if a fault (e.g., bridged tap, bad splice, etc.) is detected based on the first probe data and the fault is also detected based on the second probe data, at operation 441B, the location of the fault is declared to be downstream of the NID (e.g., within in-house wire 121). Where either one of the in-house or out-house wire is without a line impairment, such direct comparisons between multiple lines (e.g., active and dry line) may locate a detected fault relative to an NID without any actual estimate of the NID location. Such a determination is then reported out at operation 475.

In embodiments where a plurality of characterizations of a fault location relative to an NID are made, performance of the method 401 is supplemented with performance of the method 402 (FIG. 4C) and performance of method 403 (FIG. 4D). Such performance of the methods 402 and 403 may avoid incorrectly determining a fault is located after the NID, for example in the case where only one of the twisted pairs in a multi-pair in-house wire suffers from the fault (e.g., a bad splice in only one twisted pair of a quad-cable).

In FIG. 4C, method 402 similarly begins at operation 410 with detection of active and dry lines. A line (e.g., line 170A-170N in FIG. 1B) may be determined to be active or dry, as previously described. If at least one active and at least one dry line are detected, the method 402 proceeds to operation 411, where the dry line is probed to collect probe data. If no dry line is detected, the method 402 may proceed to method 403 (FIG. 4D), or another single line characterization technique may be employed. Probe data collected at operation 411 is employed to eliminate an effect of the in-house wire from the active line. In the exemplary embodiment, at operation 414, a transfer function, H₁F, of the in-house wire is estimated from the probe data collected for the dry line. At operation 415, the active line is probed to collect probe data. At operation 438, the active line probe data is processed with the transfer function H₁F to compensate for any effect of in-house wire. The equalized active line probe data is then analyzed with the template matching technique substantially as described elsewhere herein or by any known fault detection method. Any detected fault, as remaining uncompensated, is then characterized to be upstream of the NID at operation 444 and reported at operation 475.

In embodiments, a distance to the NID is determined. In one such embodiment, an estimated loop length for a dry line is utilized as the estimate for a distance between a probe point (e.g., line prober 102A in FIG. 1B) and the NID. A fault that is detected on the active line may then have a distance between the fault and probe point estimated by techniques known in the art (e.g., through comparisons in size and/or frequency of peaks in Hlog data or by analyzing reflectometry data). The estimated distances are then compared to position the detected faults as in-house or out-house.

In another embodiment, illustrated by FIG. 4D, only the active line is probed at operation 415 (e.g., where no dry line is detected). At operation 420, a distance between the probe point and the NID is estimated to be no greater than the distance between the probe point and a splice that joins the drop wire and a shielded transmission line upstream of the drop wire. FIG. 5 is a schematic illustrating a network including the system of FIG. 1B to which methods for characterizing a line with respect to the presence and/or location fault is applied, in accordance with such an embodiment. As shown, the in-house wire 121 includes the quad cable 527. On the active line 170A is the line conditioner 110 as well as POTS devices 135. Each of the lines 170A-170N have a bridged tap 345 somewhere on the CPE side of the NID 125. Upstream of the NID 125 there is a drop wire 533 that is coupled to only the active line 170A with the dry line (e.g., 170N) terminated at the NID. The drop wire 533 typically runs 50-100 feet from the NID and is spliced to a shielded transmission line 535 running to the CO 575.

In one embodiment, a distance between the location of the splice 534 and the probe point is estimated by detecting a change in the ground plane between the shielded transmission line 535 (where the shield is at ground) and the drop wire 533 (having no shield and ground therefore being a much greater distance away). This change in ground plane may be detected based on estimating a location in the line where a common mode impedance changes by more than a threshold. FIG. 5B illustrates an alternative exemplary architecture 500 in which embodiments may determine where a shielded cable and unshielded cable are joined. This determination may then be utilized to position a location of the splice 534 upstream or downstream of the drop wire joint (as a proxy for the NID location).

FIG. 5B depicts the line analyzer 570 which is communicably interfaced to a first end of an active line 550, for example, through an interface 526. In one particular embodiment, the line analyzer 570 is the line analyzer 105 (FIG. 1B) with the additional functionality described in the context of FIGS. 5B and 5C incorporated with those described in the context of FIG. 1B.

In accordance with one embodiment, line analyzer 570 includes: a signal generator 505 to inject a common mode signal probe 521 onto a first end of the 550; a signal receiver 510 to measure impedance of the common mode signal probe 521 on the line 550 at the first end; a signal detector 515 to detect an impedance anomaly 522 on the line 550 based on the measured impedance of the common mode signal probe 521. The signal analyzer 520 is to correlate an impedance anomaly 522 on the line 550 to a boundary condition 551 on the line 550. As illustrated by the dashed line box, the signal analyzer 520 may either be remote from the line analyzer 570 (e.g., part of or collocated with the data analyzer 150 at a remote third party location), or embedded in the line analyzer 570.

The line analyzer 570 may be implemented and utilized in any of the forms previously described for the line analyzer 105 (FIG. 1B). For example, in one embodiment, the line analyzer 570 is a chipset of a CPE modem communicably interfaced with the first end of the line 550 to inject the generated probe onto the line. In another embodiment, the line analyzer 570 is a chipset of a signal conditioning device physically separate and distinct from a CPE modem, in which the CPE modem is communicably interfaced with the first end of the line through a signal conditioning device (e.g., line conditioner 110 in FIG. 1B) which is communicatively interfaced to the line 550. In one embodiment, the line analyzer 570 is a controller card configured within a signal conditioning device physically separate and distinct from a CPE modem, in which the signal conditioning device is communicatively interfaced with the first end of the line 550 and in which the CPE modem is interfaced to the line 550 through the signal conditioning device. In such an embodiment, the controller card of the signal conditioning device injects the generated probe onto the line 550.

In accordance with one embodiment, the signal receiver 510 measures the impedance of the common mode signal probe 521 on the line 550 by measuring a reflection coefficient of the common mode signal probe 521 at the first end of the line 550. In such an embodiment, the signal detector 515 detects the impedance anomaly on the line 550 by detecting a change in the impedance of the line 550 based on the measured reflection coefficient.

FIG. 5C illustrates an exemplary architecture 501 in which embodiments may operate. FIG. 5C depicts the line analyzer 570 which is communicably interfaced to a first end of a line 550 in which both an unshielded portion 552 and a shielded portion 553 are depicted separated by the boundary condition 551, also referred to as a boundary or a boundary location. In accordance with one embodiment, the line analyzer 570 correlates the impedance anomaly on the line 550 to a boundary (e.g., corresponding to the boundary condition 551) separating an unshielded portion 552 of the line 550 from a shielded portion 553 of the line 550.

In one embodiment, the signal detector 515 detects the impedance anomaly on the line 550 by detecting a change in permittivity coincident with a boundary location (e.g., corresponding to the boundary condition 551) separating the unshielded portion 552 of the line 550 from the shielded portion 553 of the line 550. In such an embodiment, a first measured permittivity for the shielded portion 553 of the line 550 is consistent with a shielding material and a second measured permittivity for the unshielded portion 552 of the line 550 is consistent with an air space between a conductor of the line 550 and a ground of the line 550. Such shielding material may be, for example, Polyvinyl chloride (PVC) shielding having a permittivity in the range of approximately 2.5 to 3.0 or may be constructed from alternate shielding material, such as paper which is common in Japan. Permittivity of the air space between a conductor of the line 550 and a ground of the line 550 will typically be measured at approximately 1.0 regardless of whether the air space is a large space between the conductor and a terrestrial ground or a small air space between the conductor and a conduit housing the line 550, for example, in a sub-terrestrial environment.

Returning to FIG. 4D, if the comparison performed at operation 420 shows the estimated distance from the probe point to the fault (e.g., bridged tap 345) to be greater than the estimated distance to the splice 534 (FIG. 5A), the fault is declared at operation 422A to be upstream of the NID. Conversely, if the comparison performed at operation 420 shows the estimated distance from the probe point to the fault (e.g., bridged tap 345) is less than to the estimated distance from the probe point to the splice 534, the fault is declared to be downstream of the NID at operation 422B. As the drop wire is typically installed and maintained by a service provider and subject to few fault conditions, there is a relatively small chance of mischaracterizing a fault in the drop wire as downstream of the NID.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software, including software instructions that perform the operations described herein via memory and one or more processors of a computing platform. Embodiments also relate to a system or apparatus for performing the operations herein. The disclosed system or apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, flash, NAND, solid state drives (SSDs), CD-ROMs, and magnetic-optical disks, read-only memories (ROMs), random access memories (RAMs), EPROMs, EEPROMs, magnetic or optical cards, or any type of media suitable for storing non-transitory electronic instructions, each coupled to a computer system bus.

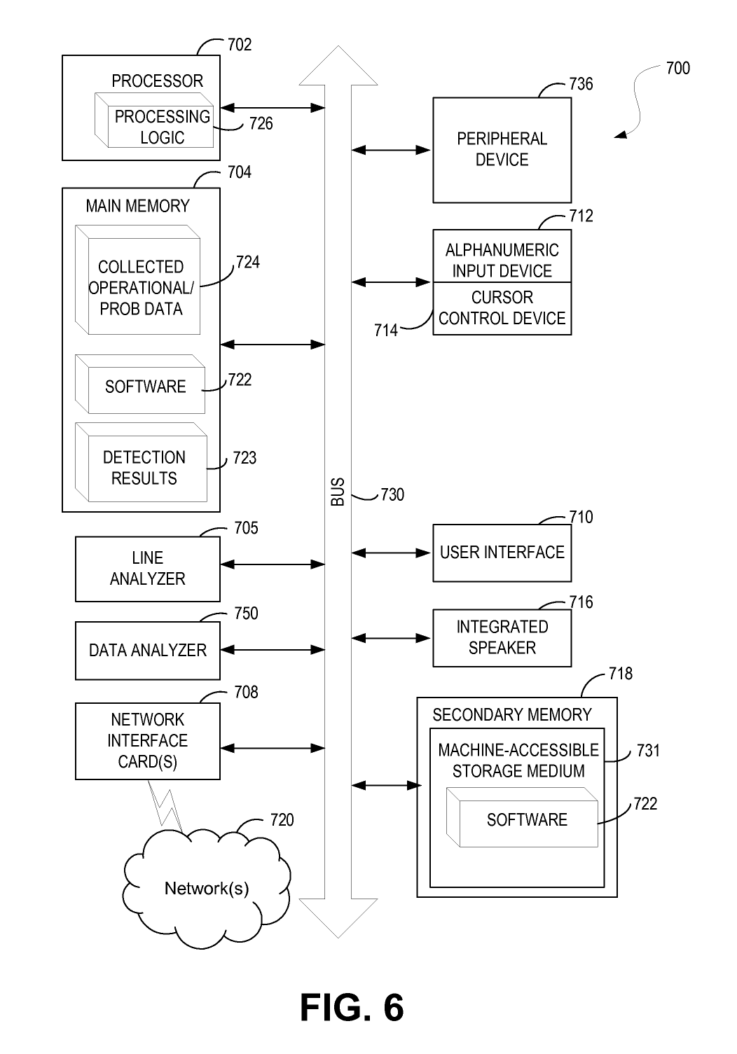

FIG. 6 illustrates a diagrammatic representation of a machine 700 in the exemplary form of a computer system, in accordance with one embodiment, within which a set of instructions, for causing the machine 700 to perform any one or more of the methodologies discussed herein, may be executed. In alternative embodiments, the machine may be connected, networked, interfaced, etc., with other machines in a Local Area Network (LAN), a Wide Area Network, an intranet, an extranet, or the Internet. The machine may operate in the capacity of a server or a client machine in a client-server network environment, or as a peer machine in a peer-to-peer (or distributed) network environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 700 includes a processor 702, a main memory 704 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 718 (e.g., a persistent storage device including hard disk drives and persistent data base implementations), which communicate with each other via a bus 730. Main memory 704 includes information and instructions and software program components necessary for performing and executing the functions with respect to the various embodiments of the systems, methods, and line probing, monitoring, and data analysis, as described herein. Detection results 723 may be generated based on, for example, analysis of the line probe and operational data. Collected data and calculations 724 are stored within main memory 704. Detection results 723 may be stored within main memory 704. Main memory 704 and its sub-elements (e.g. 723 and 724) are operable in conjunction with processing logic 726 and/or software 722 and processor 702 to perform the methodologies discussed herein.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 702 may also be one or more special-purpose processing devices such as an application specific integrated circuit (ASIC), a field programmable gate array (FPGA), a digital signal processor (DSP), network processor, or the like. Processor 702 is configured to execute the processing logic 726 for performing the operations and functionality which is discussed herein.

The computer system 700 may further include one or more network interface cards 708 to communicatively interface the computer system 700 with one or more networks 720 from which information may be collected for analysis. The computer system 700 also may include a user interface 710 (such as a video display unit, a liquid crystal display (LCD), or a cathode ray tube (CRT)), an alphanumeric input device 712 (e.g., a keyboard), a cursor control device 714 (e.g., a mouse), and a signal generation device 716 (e.g., an integrated speaker). The computer system 700 may further include peripheral device 736 (e.g., wireless or wired communication devices, memory devices, storage devices, audio processing devices, video processing devices, etc.). The computer system 700 may perform the functions of a line analyzer 705 and/or data analyzer 750 capable interfacing with digital communication lines, monitoring, collecting, analyzing, and reporting information, and initiating, triggering, and executing various line probing and operational data collection events including the execution of commands and instructions to detect conditions and/or characterize conditions on a line, as described elsewhere herein.

The secondary memory 718 may include a non-transitory machine-readable storage medium (or more specifically a non-transitory machine-accessible storage medium) 731 on which is stored one or more sets of instructions (e.g., software 722) embodying any one or more of the methodologies or functions described herein. Software 722 may also reside, or alternatively reside within main memory 704, and may further reside completely or at least partially within the processor 702 during execution thereof by the computer system 700, the main memory 704 and the processor 702 also constituting machine-readable storage media. The software 722 may further be transmitted or received over a network 720 via the network interface card 708.

The above description is illustrative, and not restrictive. For example, while flow diagrams in the figures show a particular order of operations performed by certain embodiments of the invention, it should be understood that such order may not be required (e.g., alternative embodiments may perform the operations in a different order, combine certain operations, overlap certain operations, etc.). Furthermore, many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. The scope of the invention should, therefore, be determined with reference to the appended claims, along with the full scope of equivalents to which such claims are entitled.

What is claimed is:

1. A method of characterizing a twisted pair telephone line, the method comprising:
monitoring a Public Switched Telephone Network (PSTN) state of the line;
probing the line to collect probe data in response to detecting the line to be in a particular PSTN state, or associating with the particular PSTN state, operational data collected from the line generated through operation of a Digital Subscriber Line (DSL) modem; and
characterizing the line as having a microfilter state based on the collected probe data or operational data.

2. The method of claim 1, wherein the microfilter states include at least one of:
a null microfilter with a telephone that degrades the DSL performance during an on-hook state;
a null microfilter with a telephone that does not degrade the DSL performance during an on-hook state;
a reversed microfilter; and
a correctly-configured microfilter.

3. The method of claim 1, wherein monitoring the PSTN states comprises detecting at least one of:
the presence of a Direct Current (DC) voltage;
an on-hook state;
an off-hook state; or
a ringing state.

4. The method of claim 3, wherein the associated PSTN state is the off-hook state or the ringing state.

5. The method of claim 1, wherein characterizing the line as having a microfilter state based on the collected probe data or operational data further comprises:
comparing the collected probe data to a plurality of reference line templates, each template associated with a microfilter state; and
characterizing the line as having the microfilter state associated with one of the plurality of reference line templates responsive to the comparison.

6. The method of claim 5, wherein the plurality of reference line templates comprises at least one of: field data collected from a plurality of lines, or modeled data simulating a plurality of lines; and
wherein comparing further comprises selecting a reference line template that best matches the probe data.

7. The method of claim 6, wherein selecting the reference line template that best matches the probe data comprises selecting the reference line template that best matches the probe data according to a mean square error (MSE) detection algorithm.

8. The method of claim 1, wherein collected first operational data is associated with the on-hook state detected by monitoring the PSTN state,
wherein collected second operational data is associated with the off-hook state detected by monitoring the PSTN state; and
wherein characterizing the line as having a microfilter state based on the collected probe data or operational data further comprises:
comparing the first operational data to the second operational data; and
declaring a null microfilter state where a difference indentified by the comparing exceeds a threshold.

9. The method of claim 1, wherein the line probing comprises performing active line reflectometry in response to detecting DSL activity on the line, and performing inactive line reflectometry in response to detecting no DSL activity on the line.

10. The method of claim 9, wherein performing active line reflectometry further comprises high pass filtering to avoid the PSTN band, and at least one of:
injecting a probe signal over frequency tones un-used by a DSL modem on the line; and
injecting a probe signal over a subset of the frequency tones employed by a DSL modem on the line, the subset being sufficiently small to maintain modem connectivity during the active line reflectometry.

11. The method of claim 10, wherein injecting the probe signal over a subset of the frequency tones further comprises:
dividing a DSL frequency band used by the DSL modem into a plurality of frequency tone subsets;
sequentially injecting probe signals into each of the frequency tone subsets to individually disturb each subset at a time; and
aggregating collected reflection data to generate a reflectometry waveform spanning at least a majority of the DSL frequency band.

12. The method of claim 9, wherein performing inactive line reflectometry further comprises high pass filtering to avoid the PSTN band.

13. The method of claim 1, wherein probing the line comprises performing reflectometry on the line, and wherein the method further comprises processing the probe data by low pass filtering a reflectometry waveform collected to remove line effects not attributable to microfilter states.

14. The method of claim 1, wherein the method further comprises processing the probe data by:
performing reflectometry on at least a second line lacking POTS and DSL service and is co-located with the DSL line in a same premises to characterize a line topology within the premises; and
removing an effect of the line topology from the probe data based on a reflection waveform collected from the second line.

15. The method of claim 1, wherein probing the line comprises performing reflectometry on the line while the line is in an off-hook state, the method further comprising:
probing the line a second time in response to detecting the line is in an on-hook state to generate second probe data;
performing a comparison of the probe data to the second probe data; and
characterizing the line as having a null microfilter state in response to detecting a threshold level of difference between the probe data and second probe data.

16. The method of claim 1, wherein collecting probe data further comprises collecting line reflection waveforms within a microfilter transition frequency band.

17. The method of claim 1, further comprising triggering the line probing upon receiving:
a user-initiated command; or
an indication that the line is malfunctioning in a manner consistent with a microfilter fault.

18. The method of claim 1, further comprising:
adding the probe data to the plurality of reference line templates in response to a confirmation that the microfilter on the line has the characterized microfilter state.

19. A method of characterizing a location of a fault in a twisted pair telephone line, comprising:
probing the line at a probe point downstream of a network interface device (NID) through which the line enters the customer premises to collect first probe data from the line; and
characterizing the location of the fault to be upstream or downstream of the NID based on at least the first probe data.

20. The method of claim 19, further comprising:
probing a second line lacking Digital Subscriber Line (DSL) service and co-located with the line on customer premises to collect second probe data from the second line; and
performing a comparison of the first probe data to the second probe data to characterize the location of the faults as upstream or downstream of the NID.

21. The method of claim 20, further comprising:
determining the second line has no Plain Old Telephone Service (POTS) or DSL based on a DC voltage measurement of the second line, or based on a comparison of an estimated line length of the second line with an estimated line length of the first line.

22. The method of claim 20, wherein the comparison of the first probe data to the second probe data comprises detecting the fault in the first line from the first probe data and detecting the fault in the second line from the second probe data, and wherein declaring the location of the fault comprises declaring the fault to be downstream of the NID.

23. The method of claim 19, further comprising:
estimating a distance to the NID and a distance to the fault from the probe point based on the first probe data; and
comparing the estimated distance to the NID with the estimated distance fault; and
declaring the fault to be upstream of the NID where the estimated distance to the fault is greater than the estimated distance to the NID, or downstream of the NID in the alternative.

24. The method of claim 23, wherein estimating the distance to the NID comprises:
determining from the first probe data a distance from the probe point to a splice between an unshielded drop wire and a shielded transmission line upstream of the drop wire; and
estimating the distance to the NID as less than or equal to the distance to the drop wire splice.

25. The method of claim 24, wherein the distance from the probe point the unshielded drop wire splice is based on detecting a change of ground plane between the drop wire and the shielded transmission line.

26. The method of claim 25, wherein the change of ground plane is determined based on estimating a location in the line where a common mode impedance changes by more than a threshold.

27. The method of claim 20, wherein the comparison further comprises:
removing an effect of line topology within the customer premises from the first probe data based on the second probe data, and
wherein declaring the fault comprises declaring the fault to be upstream of the NID if the effect of the line topology within the customer premises does not adequately account for the fault.

28. The method of claim 27, wherein removing an effect of line topology further comprises:
estimating a transfer function of the line topology within the customer premises based on the second probe data; and
equalizing the first probe data by the estimated transfer function.

29. A line monitor for characterizing a twisted pair telephone line, the monitor comprising:
a line prober to couple to the line downstream of a network interface device (NID) through which the line accesses customer premises, the line prober operable to probe the line, and to collect resulting probe data;
a Public Switched Telephone Network (PSTN) monitor coupled to the line and operable to monitor PSTN states of the line; and
a line probing controller communicatively coupled to the PSTN monitor and the line prober to trigger a probing of the line in response to detecting the line is in a predetermined PSTN state, and to transmit the collected probe data off the customer premises.

30. The line monitor of claim 29, wherein the PSTN monitor is to detect at least one of:
the presence of a Direct Current (DC) voltage;
an on-hook state;
an off-hook state; or
a ringing state, and
wherein the predetermined PSTN state is the off-hook state or the ring state.

31. The line monitor of claim 29, further comprising a Digital Subscriber Line (DSL) monitor to detect DSL activity on the line, wherein the line prober is to perform active line reflectometry in response to the DSL monitor detecting DSL activity on the line, and wherein the line prober is to perform inactive line reflectometry in response to detecting no DSL activity on the line.

32. The line monitor of claim 31, wherein active line reflectometry further comprises a high pass filtering to avoid the PSTN band, and at least one of:
injecting a probe signal over frequency tones un-used by a DSL modem on the line; and
injecting a probe signal over a subset of the frequency tones employed by a DSL modem on the line, the subset being sufficiently small to maintain modem connectivity.

33. The line monitor of claim 32, wherein injecting the probe signal over a subset of the frequency tones further comprises:
dividing a DSL frequency band used by the DSL modem into a plurality of frequency tone subsets;
sequentially injecting probe signals into each of the frequency tone subsets to individually disturb each subset at a time; and
aggregating over time collected reflection data to generate a reflectometry waveform spanning at least a majority of the DSL frequency band.

34. The line monitor of claim 31, wherein performing inactive line reflectometry further comprises a high pass filtering to avoid the PSTN band.

35. The line monitor of claim 29, wherein the line prober is to probe the line while the line is in an on-hook state and is to further perform a second probe of the line in response to the PSTN monitor detecting the line is in an off-hook state;
and wherein the line probing controller is to compare the probe data to second probe data generated by the second line probe, and is to characterize the line as having a null microfilter state in response to detecting a threshold level of difference between the probe data and second probe data.

36. The line monitor of claim 29, wherein the probe data collected further comprises reflection waveforms within a microfilter transition frequency band.

37. The line monitor of claim 29, wherein the line prober is further coupled to at least a second line co-located with the line on customer premises, the second line lacking Plain Old Telephone Service (POTS) and DSL service, the line prober further to perform reflectometry on at least the second line to generate second probe data; and
wherein the line probing controller is to perform a comparison of the first probe data to the second probe data and to declare a location of the fault to be upstream or downstream of the NID, based on the comparison.

38. The line monitor of claim 37, wherein the comparison of the first probe data to the second probe data comprises at least one of:
detecting the fault in the first line from the first probe data and detecting the fault in the second line from the second probe data; or
estimating distances from the line proper to each of the NID and to the fault.

39. The line monitor of claim 37, wherein the probing controller is further to process the probe data by removing an effect of the line topology from the probe data based on a reflection waveform collected from the second line.

40. The line monitor of claim 29, wherein the line probing controller is to trigger the line prober to probe the line in response to a command received from non-customer premises equipment.

41. A twisted pair telephone line analyzer, comprising:
a memory to store a plurality of reference line templates, each template associated with a microfilter state;
an interface to receive line probe data from a line prober coupled to a twisted pair telephone line; and
a processor to compare the line probe data to the reference line templates, and to characterize the line as having the microfilter state associated with a reference line template based on the comparison.

42. The line analyzer of claim 41, wherein each reference line template is further associated with a Public Switched Telephone Network (PSTN) state, wherein the line probe data is associated with a PSTN state of the line during probe, and wherein the processor is to compare only a subset of the reference line templates that is associated with the same PSTN state as the line probe data.

43. The line analyzer of claim 41, wherein the microfilter states include at least one of:
a null microfilter;
a reversed microfilter; and
a correctly-configured microfilter.

44. The line analyzer of claim 41, wherein the plurality of reference line templates comprises at least one of field data received from a plurality of lines or modeled data simulating a plurality of hypothetical lines, and
wherein processor is to select a reference line template that best matches the probe data.

45. The line analyzer of claim 44, wherein the processor is to select the reference line template by executing a MSE detection algorithm.
